(19) United States
(12) Patent Application Publication
(10) Pub. No.: US 2010/0270710 A1
(43) Pub. Date: Oct. 28, 2010

(54) FORMING METHOD OF MAGNETIC PATTERN AND MANUFACTURING METHOD OF PATTERNED MEDIA USING THE SAME

(75) Inventors: Shinill Kang, Seoul (KR); Jongill Hong, Seoul (KR)

Correspondence Address: HAMRE, SCHUMANN, MUELLER & LARSON, P.C., P.O. BOX 2902, MINNEAPOLIS, MN, 55402-0902, US

(73) Assignee: Industry-Academic Cooperation Foundation Yonsei University, Seoul (KR)

(21) Appl. No.: 12/809,681

(22) PCT Filed: Dec. 22, 2008
(86) PCT No.: PCT/KR2008/007582

§ 371 Date: Jun. 21, 2010

(30) Foreign Application Priority Data
Dec. 21, 2007 (KR) 10-2007-0135607

(51) Int. Cl. B29C 59/16

(52) U.S. Cl. 264/427

(57) ABSTRACT

The present invention relates to a method for fabricating a magnetic pattern and a method for manufacturing a patterned media through fabrication of the magnetic pattern. The method for fabricating the magnetic pattern according to an embodiment of the present invention comprises the steps of (a) coating a pattern forming layer for fabricating a magnetic pattern on a substrate; (b) forming a mask layer that has a designed opening pattern with a nano imprinting process using a stamp that has a nanostructure pattern on the pattern forming layer; and (c) converting an area of the pattern forming layer that corresponds to the predetermined opening pattern into a magnetic area by irradiating a predetermined hydrogen ion beam onto the mask layer.

### TECHNICAL FIELD

The present invention relates to a method for forming a magnetic pattern and a method for manufacturing a patterned media through formation of the magnetic pattern. In particular, the present invention relates to a method for forming a desired magnetic pattern by forming a mask pattern on a pattern forming layer through a nano imprinting process using a stamp, transferring hydrogen ion having a predetermined energy on the mask pattern to cause a reduction reaction on the layer on which the pattern is formed, and a method for manufacturing a patterned media through the formation of the magnetic pattern.

### BACKGROUND ART

In general, a magnetic information storing medium includes a magnetic layer formed on a substrate and the magnetic layer is magnetized at a predetermined interval to store information in a bit unit. Since a hard disk drive (HDD) or a hard disk device that is a representative magnetic storing medium has a large storing capacity and a rapid access speed to information, it is extensively used. As the reproducing head of the hard disk device, a MagnetoResistance effect head (hereinafter, referred to as ‘MR head’) that has a magnetoresistance effect layer having electric resistance varying in accordance to an external magnetic field is extensively used.

However, the magnetic disk recording density of the hard disk device has been continuously improved. Since a 1 bit area is reduced along with the improvement of the recording density, a signal magnetic field generated from the 1 bit area is reduced.

Accordingly, in respects to a weak signal magnetic field, it is required to use a reproducing head that outputs a large reproducing signal. In respects to the weak signal magnetic field, in order to output the large reproducing signal, a magnetoresistance effect type head using a giant magnetoresistance effect is used as the reproducing head.

FIG. 1 is a cross-sectional view of a magnetoresistance effect type head having a known magnetoresistance effect layer.

As shown in FIG. 1, the magnetoresistance effect type head is formed by laminating a magnetoresistance effect layer 3 on a substrate 2. At this time, the magnetoresistance effect layer 3 is divided into a free layer 10, a middle layer 8, a pinned layer 6, and an antiferromagnetic layer 4. The magnetization direction of the free layer 10 is changed according to an external magnetic field. The middle layer 8 is made of non-magnetic metal. The magnetization direction of the pinned layer 6 is fixed in a predetermined direction. The antiferromagnetic layer 4 is made of the antiferromagnetic material for fixing the magnetization direction of the pinned layer 6.

The resistance of the magnetoresistance effect layer 3 is changed according to the external magnetic field. For example, if the magnetization direction of the free layer 10 is changed because the external magnetic field is changed, relative angles of the magnetization direction of the pinned layer 6 and the magnetization direction of the free layer 10 are changed, as a result, the resistance is changed. Therefore, in the magnetoresistance effect type head that has the magnetoresistance effect layer 3, the intensity of output reproducing signal is almost proportional to a change in resistance varying according to a change in the magnetic field.

In the case of when a plane vertical current (vertical current) injection type spin valve is used, when resistance of the layer is R and an area of flowing sense current is A, the output of the reproducing signal of the spin valve effect type head is in proportion to Δ(RA).

Currently, in accordance with the significant advance in the information industry, there is a need to develop a magnetic storing medium having a high recording density as compared to a conventional magnetic storing medium. Accordingly, the magnetic storing medium adopts a method of forming a magnetoresistance effect layer by forming a fine pattern having a magnetic resistant electric conductivity or magnetic property, thus increasing resistance of the device and increasing Δ(RA).

The magnetic storing medium adopts a method for reducing the size of the interval of the unit for storing information to store a large amount of data in a predetermined space. However, the conventional method for reducing the size of the interval of the unit has a limit and does not have stability to information storing if overlimit is required.

Therefore, many studies have been made of patterned media in which bits that are the minimum unit of recording are physically separated from each other at predetermined pitch intervals by artificially performing patterning of a magnetic layer on a substrate so that reduced media noise, stable recording and information maintenance are ensured while the magnetic storing medium has high recording density.

The patterned media is a magnetic information storing media provides bit signal by performing magnetization of the dot in a predetermined direction after the nanosize magnetic dot is manufactured while a known method using a continuous magnetic layer is not used. The method for manufacturing the patterned media is performed by using a complicated process which comprises the steps of forming a mask pattern on a substrate as a magnetic pattern, manufacturing the pattern through processes such as etching, coating the magnetic material on the pattern, forming the magnetic patterns, filling spaces between the magnetic patterns with the non-magnetic material, and planarizing the surface thereof through processes such as CMP (Chemical mechanical polishing) and the like.

As described above, a known method for manufacturing a patterned media is performed through a complicated process and defects may occur during the complicated manufacturing process.

That is, the known pattern forming method is problematic in that etching is difficult to precisely control while an etching process is performed using the pattern that is formed on the substrate, and since the surface of the magnetic layer on which the pattern is formed through an etching process and a filling process is very rough, an additional washing process is required in conjunction with a planarization process such as CMP (Chemical Mechanical Planarization), thus complicating the process.

Meanwhile, in the known method for manufacturing the patterned media, it is required to minutely manufacture it so that the size of the unit pattern corresponding to one bit is several tens of nanoscale in order to increase the recording density. That is, in order to realize high density media of 1 Tb/in² or more, a fine patterning technology for realizing a pattern having a pitch of 25 nm is required.

However, a pattern forming method such as lithography, which is applied to a known method for manufacturing a patterned media is very difficult and expensive to achieve a fine structure of 100 nm or less. For example, in the photolithography process, a photoresist, which is a thin film, is coated on a substrate, the photoresist is'exposed to light that is irradiated with a designed pattern, and a physical pattern is formed on the substrate by using a developing process. The resolution of the pattern that is obtained by using the lithography process is problematic in that the resolution is limited by the wavelength of the light.

Therefore, as a technology for solving the problems occurring in the known pattern forming method, a nano imprinting method for premanufacturing a desired form on the surface of material having relatively high strength, putting the resulting structure on another material such as a stamp to obtain patterning or manufacture a mold having a desired shape, and coating a polymer material in the mold to form a pattern (a representative method of a nano imprinting lithography is a hot embossing method; a UV embossing method or the like) is in demand.

### DISCLOSURE

### [Technical Problem]

The present invention has been made in consideration of the above problems, and it is an object of the present invention to provide a method for forming a magnetic pattern using a mask pattern that is formed by applying a nano imprinting technology that is capable of forming high precision nano pattern.

It is another object of the present invention to provide a method for manufacturing a patterned media having small defects while at low cost through a simple manufacturing process by using a method for forming a magnetic pattern using a nano imprinting technology.

### [Technical Solution]

According to an embodiment of the present invention, a method for forming a magnetic pattern comprises the steps of (a) forming a pattern forming layer that has an electric conductivity or a magnetic property if it is reduced; (b) forming a mask layer that has a predetermined pattern by a nano imprinting process using a stamp that has a nanostructure pattern formed on a surface thereof on the pattern forming layer; and (c) irradiating a predetermined hydrogen ion beam that is accelerated with a predetermined energy onto the pattern forming layer on which the mask is arranged. In the pattern forming layer, an area that corresponds to the pattern of the mask is reacted with the hydrogen ion beam that is accelerated with a predetermined energy to be reduced.

According to another embodiment of the present invention, a method for forming a magnetic pattern comprises the steps of (a) forming a pattern forming layer that has an electric conductivity or a magnetic property if it is reduced; (b) forming a mask layer that has a predetermined pattern with a nano imprinting process using a stamp that has a nanostructure pattern formed on a surface thereof on the pattern forming layer; and (c) irradiating a hydrogen ion, which is accelerated with a predetermined energy, onto the pattern forming layer on which the mask is arranged. In the pattern forming layer, an area that corresponds to the pattern of the mask is reacted with the hydrogen ion in the plasma state, which is accelerated with a predetermined energy, to be reduced.

It is preferable that in the stamp according to the present invention, a side on which the nanostructure is formed is flat.

It is preferable that in step (b) according to the present invention, the nano imprinting process is a hot embossing method.

It is preferable that in step (b) according to the present invention, the nano imprinting process is a UV embossing method.

It is preferable that in step (c) according to the present invention, energy of hydrogen ion is irradiated at the intensity of 2 keV or less.

It is preferable that in step (a) according to the present invention, the pattern forming layer includes at least one of B, Co, Fe, Ni, Ta, Ru, Ti, Pt, Au, Mn, Pd, Cu, Cr, C, Zn, Zr, Y, Nb, Mo, Rh, Ag, Hf, W, Re, Al, Os, Ir, Nb, and oxide, nitride, and sulfide of any one thereof. It is preferable that in step (a) according to the present invention, the pattern forming layer is formed of CoₓFe_{y} oxide, and x and y satisfy the correlation that x+y=1, and 0≦x≦1.

According to another embodiment of the present invention, a method for manufacturing a patterned media through formation of a magnetic pattern comprises the steps of (a) forming a pattern forming layer that has an electric conductivity or a magnetic property if it is reduced; (b) forming a mask layer that has a designed nanodot pattern with a nano imprinting process using a stamp that has a nanostructure pattern formed on a surface thereof on the pattern forming layer; and (c) irradiating a hydrogen ion beam that is accelerated with a predetermined energy onto the pattern forming layer on which the mask is arranged. In the pattern forming layer, an area that corresponds to the nanodot pattern of the mask is reacted with the hydrogen to be reduced, thus forming the patterned media.

It is preferable that in the stamp according to the present invention, a side on which the nanostructure is formed is flat.

It is preferable that in step (b) according to the present invention, the nano imprinting process is a hot embossing method.

It is preferable that in step (b) according to the present invention, the nano imprinting process is a UV embossing method.

It is preferable that in step (c) according to the present invention, energy of hydrogen ion is irradiated at the intensity of 2 keV or less.

It is preferable that in step (a) according to the present invention, the pattern forming layer includes at least one of B, Co, Fe, Ni, Ta, Ru, Ti, Pt, Au, Mn, Pd, Cu, Cr, C, Zn, Zr, Y, Nb, Mo, Rh, Ag, Hf, W, Re, Al, Os, Ir, Nb, and oxide, nitride, and sulfide of any one thereof.

It is preferable that in step (a) according to the present invention, the pattern forming layer is formed of CoₓFe_{y} oxide, and x and y satisfy the correlation that x+y=1, and 0≦x≦1.

It is preferable that step (a) according to the present invention further includes forming a unit coated layer that includes a magnetic layer, a pattern forming layer and a non-magnetic layer disposed between the two layers, or two pattern forming layers and a non-magnetic layer disposed between the two pattern forming layers.

It is preferable that in step (a) according to the present invention, one or more unit coated layers are laminated.

It is preferable that the present invention further includes forming an antiferromagnetic layer on at least one of the upper and lower sides of one or more unit coated layers.

It is preferable that the present invention further includes forming a protective layer on one or more unit coated layers.

It is preferable that in step (a) according to the present invention, the pattern forming layer is formed by using any one of an oxide layer, a nitride layer, a sulfide layer and a combination layer thereof, or by laminating a plurality of oxide layers, nitride layers, sulfide layers or combination layers thereof.

A method for forming a magnetic pattern according to a first embodiment of the present invention comprises the steps of (a) coating a pattern forming layer for fabricating a magnetic pattern on a substrate; (b) forming a mask layer that has a predetermined opening pattern with a nano imprinting process using a stamp that has a nanostructure pattern on the pattern forming layer; and (c) converting an area of the pattern forming layer that corresponds to the predetermined opening pattern into a magnetic area by irradiating a predetermined hydrogen ion beam onto the mask layer.

A method for forming a magnetic pattern according to a second embodiment of the present invention comprises the steps of (a) coating a pattern forming layer for fabricating a magnetic pattern on a substrate; (b) forming a mask layer that has a predetermined opening pattern with a nano imprinting process using a stamp that has a nanostructure pattern on the pattern forming layer; and (c) converting an area of the pattern forming layer that corresponds to the predetermined opening pattern into a magnetic area by irradiating a hydrogen ion in a plasma state onto the mask layer.

A method for manufacturing a patterned media through formation of a magnetic pattern according to a third embodiment of the present invention comprises the steps of (a) coating a pattern forming layer for forming a magnetic pattern on a substrate; (b) forming a mask layer that has a predetermined nanodot pattern by a nano imprinting process using a stamp that has a nanostructure pattern on the pattern forming layer; and (c) converting an area of the pattern forming layer that corresponds to the predetermined nanodot pattern into a patterned media by irradiating a predetermined hydrogen ion or hydrogen ion beam onto the mask layer.

In addition, it is preferable that in step (a), the pattern forming layer is formed of a unit coated layer in which one or more magnetic layers and a non-magnetic layer disposed between the magnetic layers.

In addition, it is preferable that the pattern forming layer of the step (a) is formed by laminating one or more unit coated layers.

In addition, it is preferable that the method for manufacturing a patterned media further comprises forming an antiferromagnetic layer on at least one of the upper and lower sides of one or more unit coated layers.

In addition, it is preferable that the method for manufacturing a patterned media further comprises forming a protective layer on one or more unit coated layers.

### ADVANTAGEOUS EFFECTS

According to the present invention, by irradiating an accelerated hydrogen ion beam on a mask pattern that has various forms and a high density and is formed by using a nano imprinting process using a stamp with nanostructure is formed, an increase effect of precise formation of the magnetic pattern that has a high density and various forms may be obtained.

According to the present invention, by forming a mask pattern by using a nano imprinting process using a stamp with nanostructure is formed, there is an excellent effect of formation of the magnetic pattern that has a high density and various forms may be obtained.

In addition, according to the present invention, since a mask pattern is formed by using a stamp that is used in a nano imprinting process, without a limit in form and size of applied devices, a nanosize magnetic pattern may be fabricated.

In addition, according to the present invention, without a complicated process such as etching, filling, planarization, washing and the like, since a fine magnetic pattern may be fabricated, a manufacturing process may be simplified and manufacturing cost may be largely reduced.

In addition, by using a method for fabricating a magnetic pattern according to the present invention, a magnetic storing medium that has small defects and a flat upper side may be formed and applied to patterned media.

In addition, according to the present invention, by using a stamp with nano patterns, since the same mask pattern as a predetermined pattern on the stamp is formed and the same form and size as the mask pattern are ensured on the pattern forming layer, a nanosize magnetic patterns which are capable of being used as a patterned media that is a magnetic storing medium may be formed.

### DESCRIPTION OF DRAWINGS

FIG. 1 is a cross-sectional view of a known magnetoresistance effect layer;

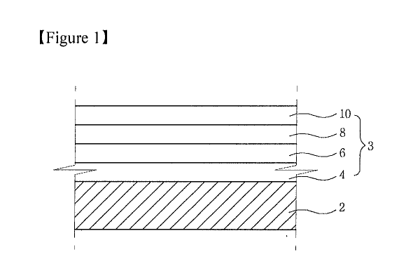

FIG. 2 is a process view that illustrates a method for forming a magnetic pattern according to a first embodiment of the present invention;

FIG. 3 is a process view that illustrates a method for forming a magnetic pattern according to a second embodiment of the present invention;

FIG. 4 is a process view that illustrates a method for manufacturing a patterned media according to a third embodiment of the present invention; and

FIG. 5 is a cross-sectional view that illustrates the form of a magnetoresistance effect layer that is formed by using the method for manufacturing the patterned media according to the third embodiment of FIG. 4.

### BEST MODE

Hereinafter, preferred embodiments of the present invention will be described in detail with reference to the accompanying drawings.

However, the present invention will be described in detail with reference to the Examples. The present invention may, however, be embodied in many different forms and should not be construed as being limited to the Examples set forth herein. Rather, these Examples are provided to fully convey the concept of the invention to those skilled in the art.

### First Embodiment

Formation of a Magnetic Pattern by a Nano Imprinting Process using a Hot Embossing Method

Hereinafter, a magnetic pattern forming method of the present invention will be described in detail with reference to the accompanying drawings.

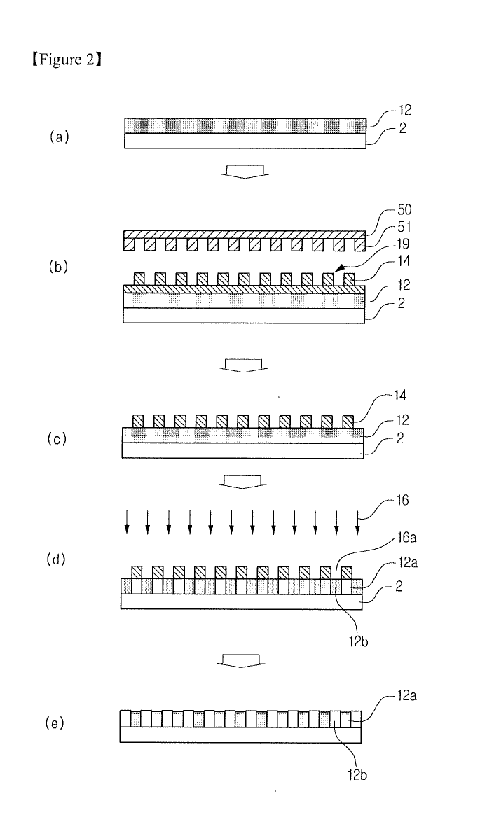

FIG. 2 is a process view that illustrates a method for forming a magnetic pattern according to a first embodiment of the present invention.

The first embodiment includes the steps of forming a pattern forming layer 12 for forming a magnetic pattern on a substrate 2; forming a mask layer that has a predetermined opening pattern by a nano imprinting process using a stamp that has a nanostructure pattern on the pattern forming layer; and converting an area of the pattern forming layer that corresponds to the predetermined opening pattern into a magnetic area by irradiating a predetermined hydrogen ion beam onto the mask layer.

In brief, first, as shown in FIG. 2A, the pattern forming layer is coated on the substrate 2. Next, as shown in FIGS. 2B and 2C, the mask pattern is formed by the nano imprinting process using the stamp with nanostructure is formed on the surface of the pattern forming layer. At this time, FIG. 2C illustrates a step of removing a remaining layer of the layer pattern. Next, as shown in FIGS. 2D and 2E, by irradiating the hydrogen ion beam that is accelerated with predetermined energy on the mask layer, the magnetic pattern is formed. At this time, FIG. 2E illustrates a step of removing the mask layer.

In more detail, first, as shown in FIG. 2A, the pattern forming layer 12 for fabricating the magnetic pattern is coated on the substrate 2. Here, the substrate 2 is not limited to a specific material or form. In detail, all semiconductor substrates that are used in semiconductor devices and data storage device may be used, and a glass substrate may be used.

At this time, the upper surface of the substrate 2 is washed by a pretreatment washing process before the pattern forming layer 12 is coated. The pretreatment washing process is performed by using DHF (Diluted H: HF solution that is diluted with H₂O at a ratio of 50:1) and SC-1 (NH₄OH/H₂O₂/H₂O solution is mixed at a predetermined ratio), or by using BOE (Buffer Oxide Etchant: HF and NH₄F mixture solution that is diluted with H₂O at a ratio of 100:1 or 300:1 [1:4 to 1:7]) and SC-1. This may be achieved by one skilled in the art of the known technology. In addition, on the substrate 2, an underlayer (not shown) may be formed. When exposure is performed in the subsequent mask process, the underlayer may be a reflection prevention layer for preventing reflection of light by the substrate 2, a separate structure layer that is required in the information storing device, or a semiconductor structure layer. The underlayer may be appropriately selected or omitted according to the case in order to perform the optimum process. Here, the pattern forming layer 12 that is formed on the substrate 2 may be formed of any one of oxide, nitride, or sulfide.

In addition, the pattern forming layer 12 that is formed on the substrate 2 may be formed of a combination of at least one or more of B, Co, Fe, Ni, Ta, Ru, Ti, Pt, Au, Mn, Pd, Cu, Cr, C, Zn, Zr, Y, Nb, Mo, Rh, Ag, Hf, W, Re, Al, Os, Ir, and Nb.

For example, in the case of when the pattern forming layer 12 that is formed on the substrate 2 is formed of oxide, the oxide is CoₓFe_{y}, wherein x and y satisfy the correlation that x+y=1, 0≦x≦1, and 0≦y≦1.

In addition, the pattern forming layer 12 may be deposited by using CVD (Chemical Vapor Deposition), PVD (Physical Vapor Deposition), LPCVD (Low Pressure CVD), PECVD (Plasma Enhanced CVD) or ALD (Atomic Layer Deposition). This may be achieved by one skilled in the art of the known technology.

In addition, if the thickness of the pattern forming layer 12 is too large or too small, since properties of devices may be reduced, the pattern forming layer 12 is deposited at a thickness of 500 Å or less and preferably 10 to 200 Å. This is because if the thickness of the pattern forming layer 12 is more than 500 Å, it is difficult to manufacture a device having an ultra-high density, and if the thickness of the pattern forming layer 12 is less than 10 Å, thermal instability exists in the device.

Here, on the upper part of the pattern forming layer 12, a predetermined protective layer (not shown) may be additionally formed. This protective layer is used to prevent an increase in surface roughness due to damage to the upper surface of the pattern forming layer 12, for example, damage due to etching the upper surface of the pattern forming layer 12 in the subsequent mask process, washing process or heat treatment process. The protective layer may be made of a metal layer and so on. This may be achieved by one skilled in the art of the known technology.

Next, as shown in FIGS. 2B and 2C, the method for forming the magnetic pattern according to the present invention forms a mask layer as the pattern forming layer 12 by the nano imprinting process using the stamp with thenanostructure is formed on the surface thereof.

Here, the nano imprinting process replicates the stamp 50 (for example, mold and the like), on one side of which the pattern of the nanostructure 51 (combination of convex and concave parts) is formed, on the polymer layer 19 (or polymer layer). As the nano imprinting method, there are a hot embossing method, a UV embossing method and the like. In the first embodiment, the hot embossing method is applied. In respects to the hot embossing method, this may be achieved by one skilled in the art of the known technology. Accordingly, the description thereof will be omitted.

That is, in the present invention, when the mask layer is formed, in the case of when the hot embossing method is used as the nano imprinting process, as shown in FIGS. 2B, the premanufactured stamp 50 (mold) on which the pattern 51 of the nanostructure is formed is pressed on the polymer layer 19, heated to a glass-transition temperature of the polymer or higher, and cooled. At this time, the material of the polymer that is used in the polymer layer 19 may be thermoplastic and thermosetting resins. Therefore, almost all polymer materials may be used. On the surface of the polymer layer 19, if the nanopattern 51 form of the stamp 50 is replicated, the polymer layer 19 is separated from the stamp 50. Accordingly, as shown in FIG. 2C, the mask layer 14 is formed on the pattern forming layer 12. The mask layer 14 has the pattern that includes combinations of concave and convex parts. That is, the mask layer 14 is formed of the nanosize pattern having a desired form using the polymer (for example, trademark: PMMA, ZEP 520 and the like). This may be achieved by one skilled in the art of the known technology. Accordingly, the description thereof will be omitted.

Meanwhile, as shown in FIG. 2C, after the mask layer 14 is formed on the pattern forming layer 12, a process for removing a pattern residual layer of the mask layer 14 may be further performed. Needless to say, the pattern of the mask layer 14 according to the present invention may be a negative type or a positive type.

Next, as shown in FIG. 2C, through the mask layer 14 that is formed by the nano imprinting process and has the nanosize pattern, on the pattern forming layer 12, the hydrogen ion beam 16 is transferred. That is, through an opening 16a on the mask layer 14, if the pattern forming layer 12 is exposed to the hydrogen ion beam 16, the corresponding area of the pattern forming layer 12 is converted to be an electric conductor 12a (or magnet) due to the reduction in hydrogen. At this time, the area 12b of the pattern forming layer 12, which is not exposed to the hydrogen ion beam 16, is a nonconductor 12b (or non-magnet). The hydrogen ion beam 16 means a flow of ions that is converged in a predetermined direction. This may be achieved by one skilled in the art of the known technology. Accordingly, the description thereof will be omitted.

Here, in order for the reduction reaction of the magnetic pattern to be generated by using the hydrogen ion beam 16, by exposing the pattern forming layer 12 to the hydrogen ion environment, the reaction with the hydrogen ion may be performed. However, it is more preferable to accelerate the hydrogen ion in the chamber (not shown) to transfer the hydrogen ion on the pattern forming layer 12.

At this time, it is more preferable that energy of the hydrogen ion constituting the hydrogen ion beam 16 is in the range of 0 to 2 keV. In the case of when energy of the hydrogen ion is more than 2 keV, in the transferring of the energy of the hydrogen ion, damage to an interface of the substrate 2 and the pattern forming layer 12 and the layer structure may occur or crystal structures may be deformed.

Several hydrogen reduction reactions of the present invention are shown in the following Reaction Equations.

### [Reaction Equation 1]

2CoO+2H₂→2Co+2H₂O

When CoO constituting the pattern forming layer is reduced, H or H⁺ may be used in addition to H₂. As a result, Co is reduced in the metal magnetic layer. H₂O is discharged to the air or discharged through a vacuum pump and the like to the air.

### [Reaction Equation 2]

2FeO+2H₂→2Fe+2H₂O

When FeO constituting the pattern forming layer is reduced, H or H⁺ may be used in addition to H₂. As a result, Fe is reduced in the metal magnetic layer. H₂O is discharged to the air (or discharged through a vacuum pump and the like to the air).

### [Reaction Equation 3]

Fe₂O₃+3H₂→2Fe+3H₂O

When Fe₂O₃ that is the antiferromagnet constituting the pattern forming layer is reduced, H or H⁺ may be used in addition to H₂. As a result, Fe is reduced in the metal magnetic layer. H₂O is discharged to the air or discharged through a vacuum pump and the like to the air.

The above hydrogen reduction reactions are examples of the hydrogen reduction reaction of the present invention, and the hydrogen reduction reaction of the present invention is not limited thereto.

In other words, while transferring the hydrogen ion beam, the pattern forming layer 12 forms the magnetic pattern that has the magnetic area and the non-magnetic area. That is, the pattern forming layer 12 is converted into the layer that has the magnetic pattern including the electric conductor 12b and the electric non-conductor 12a. As described above, in the portion of the pattern forming layer 12, which is exposed through the opening 16a formed on the pattern of the mask layer 14, the hydrogen reduction reaction occurs. Thus, the corresponding area of the pattern forming layer 12 is reacted with the hydrogen ion to be reduced into the electric conductor 12b (or, magnet), and since the portion that is not exposed is not reacted with the hydrogen ion, it is used as the electric insulator 12a (or non-magnet).

Here, the size of the pattern that is formed on the mask layer 14 formed by the nano imprinting according to the present invention may be 1 mm or less which corresponds to the size of the pattern of the mask layer and it may be formed without defects.

Finally, after the pattern forming layer 12 is converted into the layer having the magnetic pattern by transferring the hydrogen ion beam, by performing a strip) process, the mask layer 14 may be removed. Accordingly, the configuration of FIG. 2E is obtained. Unlike this, in the case of when the mask layer 14 is formed of photoresists, it can not be removed.

Meanwhile, after the mask layer 14 is removed, by depositing metal, polymer, or insulators on the pattern forming layer 12, the protective layer (not shown) for protecting the pattern forming layer 12 may be formed. In the case of when the mask layer 14 is formed of the photoresists, on the mask layer 14, the protective layer may be formed. This may be achieved by one skilled in the art of the known technology. Accordingly, the description thereof will be omitted.

As described above, the first embodiment forms the mask pattern by the nano imprinting process using the stamp with nanostructure is formed, thus forming the magnetic pattern that has high density and various forms.

Unlike a known method for forming a pattern, the first embodiment may form the magnetic pattern that includes the magnetic area and the non-magnetic area on the pattern forming layer magnetic having the same pattern as that of the mask layer formed by the nano imprinting without a process for etching the pattern forming layer 12, filling the etched portion, and planarizing the surface of the pattern forming layer, and while the magnetic pattern is formed, etching, filling and planarizing processes are not performed, thus deformation or a damage does not occur.

Therefore, the first embodiment may provide an increase effect of precise formation of the magnetic pattern that has high density and various forms by irradiating the accelerated hydrogen ion beam on the mask layer that has the high density and various forms and is formed by the nano imprinting process using the stamp with nanostructure is formed.

### Second Embodiment

### Formation of a Magnetic Pattern by a Nano Imprinting Process Using a UV Embossing Method

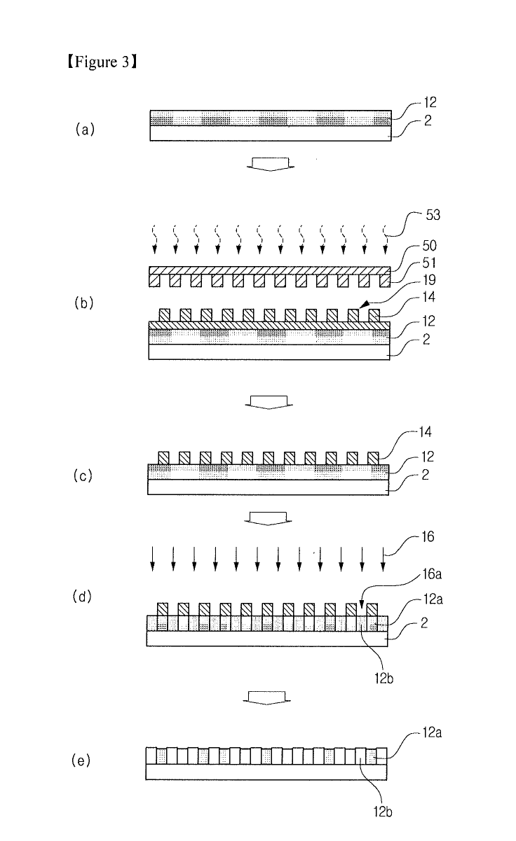

Hereinafter, a magnetic pattern forming method according to the second embodiment of the present invention will be described in detail with reference to the accompanying drawings. In the following description, the same constitutional elements as the first embodiment are omitted. FIG. 3 is a process view that illustrates a method for forming a magnetic pattern according to a second embodiment of the present invention.

The second embodiment includes the steps of forming a pattern forming layer 12 for forming a magnetic pattern on a substrate 12; forming a mask layer 14 that has a predetermined pattern by a nano imprinting process using a stamp 50 that has a nanostructure pattern on the pattern forming layer 12; and converting an area of the pattern forming layer 12 that corresponds to the predetermined opening pattern into a magnetic area by irradiating predetermined hydrogen ion 16 in a plasma state onto the mask layer 14. Here, since the plasma includes neutral ions, only the ions are collected by acceleration. Since the technology regarding the plasma may be easily understood from a known technology by those who are skilled in the art, the detailed description thereof will be omitted.

In brief, first, as shown in FIG. 3A, the pattern forming layer is coated on the substrate 2. Next, as shown in FIGS. 3B and 3C, the mask pattern is formed by the nano imprinting process using the stamp with the nanostructure is formed on the surface of the pattern forming layer. At this time, FIG. 3C illustrates a step of removing a remaining layer of the layer pattern. Next, as shown in FIGS. 3D and 3E, by irradiating the hydrogen ion in the plasma state that is accelerated with predetermined energy on the mask layer, the magnetic pattern is formed. At this time, FIG. 3E illustrates a step of removing the mask layer.

In more detail, first, as shown in FIG. 3A, the pattern forming layer 12 for forming the magnetic pattern is coated on the substrate 2. Here, the substrate 2 is not limited to a specific material or form. In detail, all semiconductor substrates that are used in semiconductor devices and information storing devices may be used, and a glass substrate may be used.

At this time, the upper surface of the substrate 2 is washed through a pretreatment washing process before the pattern forming layer 12 is formed. The pretreatment washing process is performed by using DHF (Diluted H: HF solution that is diluted with H₂O at a ratio of 50:1) and SC-1 (NH₄OH/H₂O₂/H₂O solution is mixed at a predetermined ratio), or by using BOE (Buffer Oxide Etchant: HF and NH₄F mixture solution that is diluted with H₂O at a ratio of 100:1 or 300:1 [1:4 to 1:7]) and SC-1. Since This may be achieved by one skilled in the art of the known technology, and the detailed description thereof will be omitted.

In addition, on the substrate 2, an underlayer (not shown) may be formed. When exposure is performed in the subsequent mask process, the underlayer may be a reflection prevention layer for preventing reflection of light by the substrate 2, a separate structure layer that is required in the information storing device, or a semiconductor structure layer. The underlayer may be appropriately selected or omitted according to the case in order to perform the optimal processes.

Here, the pattern forming layer 12 that is formed on the substrate 2 may be formed of any one of oxide, nitride, or sulfide.

In addition, the pattern forming layer 12 that is formed on the substrate 2 may be formed of a combination of at least one or more of B, Co, Fe, Ni, Ta, Ru, Ti, Pt, Au, Mn, Pd, Cu, Cr, C, Zn, Zr, Y, Nb, Mo, Rh, Ag, Hf, W, Re, Al, Os, Ir, and Nb.

For example, in the case of when the pattern forming layer 12 that is formed on the substrate 2 is formed of oxide, the oxide is CoₓFe_{y}, and x and y satisfy the correlation that x+y=1, 0≦x≦1, and 0≦y≦1.

In addition, the pattern forming layer 12 may be deposited by using CVD (Chemical Vapor Deposition), PVD (Physical Vapor Deposition), LPCVD (Low Pressure CVD), PECVD (Plasma Enhanced CVD) or ALD (Atomic Layer Deposition). This may be achieved by one skilled in the art of the known technology, and the detailed description thereof will be omitted.

In addition, if the thickness of the pattern forming layer 12 is too large or too small, since properties of devices may be reduced, the pattern forming layer 12 is deposited at a thickness of 500 Å or less and preferably 10 to 200 Å. This is because if the thickness of the pattern forming layer 12 is more than 500 Å, it is difficult to manufacture a device having an ultra-high density, and if the thickness of the pattern forming layer 12 is less than 10 Å, thermal instability exists in the device.

On the upper part of the pattern forming layer 12, a predetermined protective layer (not shown) may be additionally formed. This protective layer is used to prevent an increase in surface roughness due to damage to the upper surface of the pattern forming layer 12, for example, damage due to etching the upper surface of the pattern forming layer 12 in the subsequent mask process, washing process or heat treatment process. The protective layer may be made of a metal layer. This may be achieved by one skilled in the art of the known technology, and the detailed description thereof will be omitted.

Next, as shown in FIGS. 3B, the mask pattern is formed by the nano imprinting process using the stamp with the nanostructure is formed on the surface thereof as the pattern forming layer.

Here, the nano imprinting process replicates the nanosize form 51 on the surface of the stamp 50 (mold), on the polymer layer 19 (polymer layer), and in respects to the nano imprinting method, the application of the UV embossing method to the nano imprinting process will be described. That is, the UV embossing method may be applied to the nano imprinting process that is shown in FIG. 3B, and the UV embossing method is a method in which the polymer 19 having a photocurable property is used and cured by UV 53. That is, the UV embossing method may perform a process at room temperature and low pressure unlike a thermal nanoimprinting method that is performed at high temperature and pressure.

At this time, in the nano imprinting process using the UV embossing method, as the material of the polymer 19, various photocurable polymer materials (for example, polymer material that is cured by ultraviolet rays and the like) may be used.

Therefore, the second embodiment is advantageous in that a process time is reduced and stamps 50 (mold) of various materials are used as compared to a known art. This technology may be applied to a technology using an elementwise patterned stamp (EPS) to manufacture a mask layer 14 on a substrate 2 using a single process and a method such as a step-and-repeat process for continuously performing various processes to form a pattern on an entire substrate. That is, the mask layer 14 is formed of the nanosize pattern having a desired form using the polymer (for example, trademark: PMMA, ZEP 520 and the like).

Needless to say, the pattern of the mask layer 14 according to the second embodiment may be a negative type or a positive type.

Here, as shown in FIG. 3C, in the nano imprint process, a process for removing a pattern residual layer of the mask 14 may be further performed.

Next, as shown in FIG. 3D, through the mask layer 14 that is formed by the nano imprinting process and has the nanosize pattern, on the pattern forming layer 12, the hydrogen ion 16 in a plasma state is transferred. That is, in the pattern forming layer 12 that is exposed through an opening 16a on the mask layer 14, the corresponding area thereof is converted into an electric conductor 12a (or magnet) because of hydrogen reduction by the hydrogen ion in a plasma state. Here, for the reduction reaction of the magnetic pattern using the hydrogen ion 16 in a plasma state, by exposing the pattern forming layer 12 to the hydrogen ion environment, the reaction with the hydrogen ion may be performed. However, it is more preferable to accelerate the hydrogen ion in a plasma state in the chamber (not shown) to transfer the hydrogen ion on the pattern forming layer 12.

It is preferable that energy of the hydrogen ion is in the range of 0 to 2 keV. In the case of when energy of the hydrogen ion is more than 2 keV, in the transferring of the energy of the hydrogen ion, a damage to an interface of the substrate 2 and the pattern forming layer 12 and the layer structure may occur or crystal structures may be deformed.

As described above, the pattern forming layer 12 is converted into the layer of the magnetic pattern that has an electric conductor 12b formed by transferring of the hydrogen ion in a plasma state. Needless to say, the area of the pattern forming layer 12, which is not reduced, is used as a nonconductor 12a. The size of the pattern that is formed according to the mask pattern formed by using the nano imprinting according to the second embodiment may be 1 mm or less which corresponds to the size of the mask pattern and it may be formed without defects.

Finally, the pattern forming layer 12 is converted into the layer having the magnetic pattern by transferring the hydrogen ion 16 in a plasma state, by performing a strip) process, the mask layer 14 may be removed. Accordingly, the configuration of FIG. 3E is obtained. In the case of when the mask layer 14 is formed of photoresists, it may not be removed. This may be achieved by one skilled in the art of the known technology, and the detailed description thereof will be omitted.

In a state of FIG. 3E in which the mask layer 14 is removed, by depositing metal, polymer, or insulators on the pattern forming layer 12 that is converted into the layer having the magnetic pattern, the protective layer (not shown) for protecting the magnetic patterns 12a and 12b may be formed. In the case of when the mask layer 14 is formed of the photoresists, on the mask layer 14, the protective layer may be formed. This may be achieved by one skilled in the art of the known technology, and the detailed description thereof will be omitted.

As described above, the second embodiment forms the mask pattern by the nano imprinting process using the stamp with the nanostructure is formed, thus forming the magnetic pattern that has high density and various forms.

Unlike a known method for forming a pattern, the second embodiment may form the magnetic pattern that has the same pattern as the mask pattern formed by the nano imprinting without a process for etching the pattern forming layer 12, filling the etched portion, and planarizing the surface of the pattern forming layer, and while the magnetic pattern is formed, etching, filling and planarizing processes are not performed, thus deformation or a damage does not occur.

herefore, the second embodiment may provide an increase effect of precise formation of the magnetic pattern that has the high density and various forms by irradiating the accelerated hydrogen ion in a plasma state on the mask pattern that has the high density and various forms and is formed by the nano imprinting process using the stamp with the nanostructure is formed.

### Third Embodiment

Manufacturing of a Patterned Media Having a Magnetic Effect Layer Through Formation of a Magnetic Pattern that is Formed by Using a Nano Imprinting Process

Hereinafter, a method for manufacturing a patterned media using a method for forming a magnetic pattern according to the third embodiment of the present invention will be described. Here, a magnetoresistance effect layer and a patterned media may be formed by using a method for forming a magnetic pattern according to the present invention. In the following description, the same constitutional elements as the first and the second embodiments are omitted.

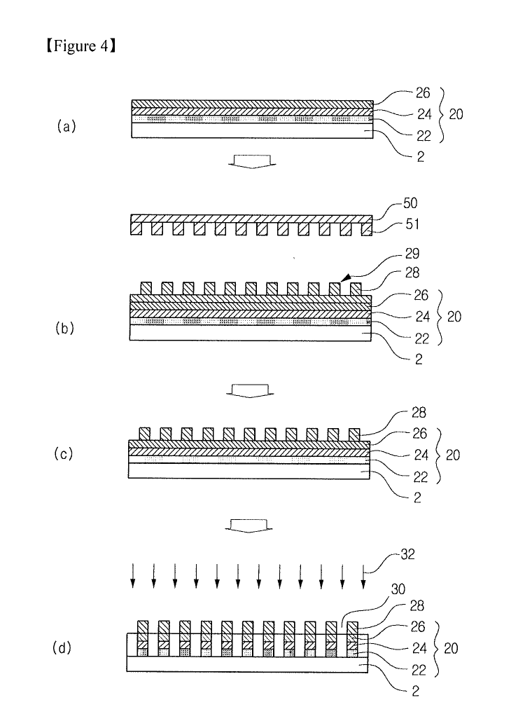

FIG. 4 is a process view that illustrates a method for manufacturing a patterned media according to a third embodiment of the present invention.

First, as shown in FIG. 4A, a coated layer that forms a nano pattern dot and magnetoresistance effect of a patterned media is formed on the substrate 2. That is, a first layer 22, a second layer 24, and a third layer 26 that form the magnetoresistance effect layer 20 are sequentially laminated on the substrate 2.

The first layer to the third layer 22, 24, and 26 of the magnetoresistance effect layer 20, which are laminated as described above, correspond to any one of a pinned layer, a middle layer, and a free layer. Here, the pinned layer is referred to as a layer in which a magnetization direction is fixed, and the free layer is referred to as a layer in which a magnetization direction is not fixed.

Therefore, the magnetoresistance effect layer 20 may be obtained by sequentially laminating the pinned layer, the middle layer, and the free layer on the substrate or sequentially laminating the free layer, the middle layer, and the pinned layer.

Hereinafter, in the following description, the magnetoresistance effect layer 20 includes the first layer 22 as the pinned layer, the second layer 24 as the middle layer, and the third layer 26 as the free layer, or the first layer 22 as the free layer, the second layer 24 as the middle layer, and the third layer 26 as the pinned layer.

Therefore, the first layer 22 and the third layer 26 of the magnetoresistance effect layer are a layer corresponding to the pinned layer or the free layer of the magnetoresistance effect layer, and are made of a magnetic material.

In order to maximize the magnetoresistance effect of the magnetoresistance effect layer, a fine magnetic pattern is formed on at least one of the first layer 22 or the third layer 26.

Accordingly, at least one of the first layer 22 and the third layer 26 is formed of the pattern forming layer like the first embodiment and the second embodiment (hereinafter, the first layer 22 and the third layer 26 of the magnetoresistance effect layer are the same as the pattern forming layer).

Here, the magnetoresistance effect layer 20 may be deposited by using CVD (Chemical Vapor Deposition), PVD (Physical Vapor Deposition), LPCVD (Low Pressure CVD), PECVD (Plasma Enhanced CVD) or ALD (Atomic Layer Deposition). This may be achieved by one skilled in the art of the known technology, and the detailed description thereof will be omitted. In addition, if the thickness of each layer of the magnetoresistance effect layers 20 is too large or too small, since properties of devices may be reduced, each layer is deposited at a thickness of 500 Å or less and preferably 10 to 200 Å. This is because if the thickness of each layer is more than 500 Å, it is difficult to manufacture a device having ultra-high density, and if the thickness of each layer is less than 10 Å, thermal instability exists in the device.

Here, the pattern forming layer of the magnetoresistance effect layers 20 that are formed on the substrate 2, for example, a first layer and a third layer, may be formed of any one of oxide, nitride, or sulfide.

In addition, the pattern forming layer of the magnetoresistance effect layers 20 that are formed on the substrate 2 may be formed of a combination of at least one or more of B, Co, Fe, Ni, Ta, Ru, Ti, Pt, Au, Mn, Pd, Cu, Cr, C, Zn, Zr, Y, Nb, Mo, Rh, Ag, Hf, W, Re, Al, Os, Ir, and Nb.

For example, in the case of when the pattern forming layer of the magnetoresistance effect layers 20 that are formed on the substrate 2 is formed of oxide, the oxide is CoₓFe_{y}, and x and y satisfy the correlation that x+y=1, 0≦x≦1, and 0≦y≦1.

In addition, an antiferromagnet layer (not shown) may be formed on the pattern forming layer of the magnetoresistance effect layer 20, that is, on the outersurface of the layer that forms the pinned layer of the first layer 22 and the third layer 26). Therefore, in the case of when the first layer 22 forms the pinned layer, the antiferromagnet layer is formed between the substrate 2 and the first layer 22, and in the case of when the third layer 26 forms the pinned layer, the antiferromagnet layer is formed on the third layer 26. Here, the antiferromagnet layer fixes a magnetization direction of the pinned layer to stabilize the magnetization of the pinned layer and increase a magnetoresistance effect.

In addition, after the first layer to the third layer 22, 24, and 26 and the antiferromagnet layer are laminated on the substrate 2, a predetermined protective layer (not shown) may be additionally formed on the laminated structure. The protective layer prevents damage to the upper surface of the magnetoresistance effect layer when a subsequent mask process, or a washing process or a heat treatment process is performed, and an increase in surface roughness when the upper surface of the third layer 26 or the ferromagnetic layer is etched. A metal layer may be used as the protective layer. This may be achieved by one skilled in the art of the known technology, and the detailed description thereof will be omitted.

Next, as shown in FIGS. 4B and 4C, the pattern forming layer of the magnetoresistance effect layers 20 on which the nanodot pattern is formed to manufacture the patterned media is used to form a mask layer 28 on which the pattern is formed by the nano imprinting process using the stamp 50 with the nanostructure is formed.

Here, the nano imprinting process replicates the nanosize form on the surface of the stamp (mold), on the polymer layer (polymer layer), and may be applied to, for example, a hot embossing method or a UV embossing method. This may be achieved by one skilled in the art of the known technology, and the detailed description thereof will be omitted.

That is, as shown in FIG. 4B, in the case of when the hot embossing method is used as the nano imprinting process while the mask pattern is formed, the premanufactured stamp 50 (mold) that has the pattern having the nanostructure is pressed on the polymer layer 29, heated to a glass-transition temperature of the polymer or more, and cooled. In this process, if the form of the nanopattern 51 of the stamp 50 is replicated on the surface of the polymer layer 29, the polymer layer 29 is separated from the stamp 50 to form the mask layer 28 having a predetermined pattern. The material of the polymer that is used in the polymer layer 29 may be thermoplastic and thermosetting resins. Therefore, almost all polymer materials may be used. In addition, as shown in FIG. 4C, a process for removing a pattern residual layer of the polymer layer in the nanoimprinting process may be further performed. This may be achieved by one skilled in the art of the known technology, and the detailed description thereof will be omitted. Meanwhile, as shown in FIG. 4B, a UV embossing method may be used in the nano imprinting process, and the UV embossing method is a method for curing it by using a photocurable polymer and UV. That is, the UV embossing method may be performed at normal temperature and low pressure unlike the thermal nanoimprinting process which is performed at high temperature and pressure. Because of these advantages, a process time may be reduced, and molds of various materials may be used. This technology may be applied to a technology using an elementwise patterned stamp (EPS) to manufacture a nanodot pattern on an entire substrate using a single process and a method such as a step-and-repeat process for continuously performing various processes to form a nanodot pattern on an entire substrate.

At this time, in the nano imprinting process using the UV embossing method, various photocurable polymer materials (for example, the polymer material that is cured by ultraviolet rays) may be used as the polymer material.

As described above, in the third embodiment of the present invention, in the case of when the substrate 2 or the protective layer is formed by the nano imprinting process, the mask layer 28 is provided on the protective layer. The mask layer 28 may be formed on the entire structure or spaced apart from the entire structure at a predetermined interval. That is, the mask layer 28 may be formed of the nanosize pattern having a desired form, that is, the nanodot pattern, using the polymer (for example, trademark: PMMA, ZEP 520 and the like). Needless to say, the pattern of the mask layer 28 according to the present invention may be a negative type or a positive type.

Next, as shown in FIG. 4D, through the mask layer 28 that has the nanodot pattern and is formed by the nano imprinting process, the hydrogen ion in a plasma state or the hydrogen ion beam 32 is transferred to the pattern forming layer of the magnetoresistance effect layer 20. That is, the pattern forming layer of the magnetoresistance effect layer 20 exposed through the opening 30 of the mask layer 30 is converted into an electric conductor (or magnet) by hydrogen reduction using the hydrogen ion 32 to form the magnetic pattern having the nanodot pattern.

Through this, as shown in FIG. 4E, the present invention forms the pattern forming layer that has the magnetic pattern including the nanodot pattern among the magnetoresistance effect layers 20 on the substrate. Thus, the first layer 22 and the third layer 26 of the magnetoresistance effect layer 20 form the pinned layer or the free layer of the magnetoresistance effect layer.

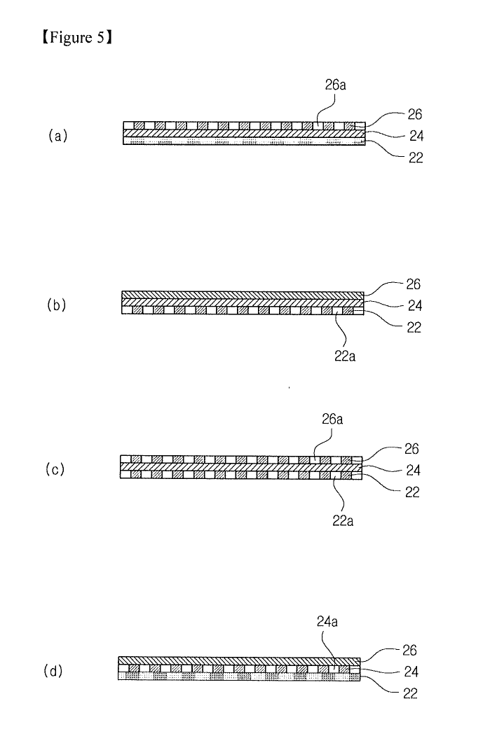

FIG. 5 is a cross-sectional view that illustrates the form of a magnetoresistance effect layer that is formed by using the method for manufacturing the patterned media of the third embodiment of FIG. 4.

With reference to FIG. 5, various forms of magnetoresistance effect layers may be provided to obtain the patterned media according to the third embodiment. By controlling energy of the hydrogen ion in a plasma state or the hydrogen ion beam 32 that is irradiated as shown in FIG. 4D in the third embodiment, it can be seen that the hydrogen ion is reacted with which layer of the first layer 22 and the third layer 26.

Here, in the case of when irradiation energy of the hydrogen ion 32 is changed and controlled, it is preferable that energy of the hydrogen ion is in the range of 0 to 2 keV. In the case of when energy of the hydrogen ion is larger than 2 keV, a damage to the interface of the substrate 2, the magnetoresistance effect layer 20, and the layer structure may occur or a crystal structure may be deformed while energy of the hydrogen ion is transferred.

As an example of the magnetoresistance effect layer, as shown in FIG. 5A, in the case of when the third layer 26 of the magnetoresistance effect layer 20 is the pattern forming layer, since the irradiated hydrogen ion in a plasma state or the irradiated hydrogen ion beam 32 causes the hydrogen reduction through the portion 30 exposed by the mask layer 28 in the third layer 26, the portion 26a that corresponds to the pattern 30 of the third layer 26 is converted into the magnet (see FIG. 4D).

In addition, as another example of the magnetoresistance effect layer, as shown in FIG. 5B, in the case of when the first layer 22 is the pattern forming layer, since the irradiated hydrogen ion in a plasma state or the irradiated hydrogen ion beam 32 is transferred to the first layer 22 through the portion 30 exposed by the mask layer 28 to cause the hydrogen reduction, the portion 22a that corresponds to the pattern 30 of the first layer 22 is converted into the magnet (see FIG. 4D).

In addition, as another example of the magnetoresistance effect layer, as shown in FIG. 5C, in the case of when the patterns are formed on the first layer 22 and the third layer 26, by using the first layer 22 and the third layer 26 as the pattern forming layer to use both irradiation energies of the hydrogen ion in a plasma state and the hydrogen ion beam 32 or to sequentially irradiate the hydrogen ion in a plasma state of another energy or the hydrogen ion beam 32, thus converting portions 22a and 26a that correspond to an exposed portion 30 of the mask layer of the first layer 22 and the third layer 26 into the magnet.

Some examples of the hydrogen reduction reaction that occur in the pattern forming layer of the magnetoresistance effect layer according to the present embodiment are shown in the following Reaction Equations.

### [Reaction Equation 4]

2CoO+2H₂→2Co+2H₂O

When CoO constituting the pattern forming layer is reduced, H or H⁺ may be used in addition to H₂. As a result, Co is reduced in the metal magnetic layer. H₂O is discharged to the air (or discharged through a vacuum pump and the like to the air).

### [Reaction Equation 5]

2FeO+2H₂→2Fe+2H₂O

When FeO constituting the pattern forming layer is reduced, H or H⁺ may be used in addition to H₂. As a result, Fe is reduced in the metal magnetic layer. H₂O is discharged to the air (or discharged through a vacuum pump and the like to the air).

### [Reaction Equation 6]

Fe₂O₃+3H₂→2Fe+3H₂O

When Fe₂O₃ that is the antiferromagnet constituting the pattern forming layer is reduced, H or H⁺ may be used in addition to H₂. As a result, reduced Fe constitutes the metal magnetic layer. H₂O is discharged to the air (or discharged through a vacuum pump and the like to the air).

The above hydrogen reduction reactions are examples of the hydrogen reduction reaction of the present invention, and the hydrogen reduction reaction of the present invention is not limited thereto.

Through the hydrogen reduction reaction, the portion of the pattern forming layer of the first layer 22 or the third layer 26, which corresponds to the pattern 30, is reacted with the hydrogen ion to be reduced to the magnet, and the residual portion thereof is used as the non-magnet.

As described above, by transferring the hydrogen ion in a plasma state or the hydrogen ion beam, a fine pattern that includes a magnet is formed on the pattern forming layer, and the first layer 22 to the third layer 36 become a magnetoresistance effect layer having a magnetoresistance effect by the fine pattern.

Next, after the mask layer is removed, a predetermined bit may be stored in the nanodot pattern formed as described above. That is, by forming magnetization in a predetermined direction in the nanodot pattern, a patterned media having the bit signal may be formed.

In addition, the third embodiment of the present invention reduces a portion of the pattern forming layer by transferring the hydrogen ion in a plasma state or the hydrogen ion beam.

However, the pattern forming layer that is exposed by the nanodot pattern of the mask layer may be exposed to the hydrogen ion in a plasma state or the hydrogen ion beam to be reduced into an electric conductor (or magnet).

In addition, the third embodiment of the present invention may perform a strip process after the transferring of the hydrogen ion in a plasma state or the hydrogen ion beam is finished to remove the mask layer. At this time, in the case of when the mask layer is made of photoresist, the mask layer may not be removed.

After the mask layer is removed, by depositing metal, polymer, insulating material and the like on the pattern forming layer of the magnetoresistance effect layer, a protective layer (not shown) for protecting the pattern forming layer 20 may be formed. In the case of when the mask layer is made of photoresist, a protective layer may be formed on the mask layer.

The third embodiment of the present invention may be applied to all methods for manufacturing fine patterns of devices that include an electric insulator and a conductor.

To be specific, the third embodiment of the present invention describes the reduction of the pattern forming layer into the material having the magnetic property. However, the pattern forming layer may be reduced into a material having an electric conductivity. In this case, as shown in FIG. 5D, the pattern forming layer becomes a magnetoresistance effect layer in which a middle layer 24 having an electric conductive pattern 24a between a pinned layer 22 having a magnetic property and a free layer 26 is arranged.

In addition, in the third embodiment of the present invention, the pattern forming layer is formed of the non-magnetic oxide. However, the pattern forming layer may be formed of the antiferromagnetic oxide. In this case, since the oxidized magnetic layer exists in an antiferromagnet form without additional lithography process and can be used as a hard bias for stabilizing the free layer, an easy process is ensured in views of technical configuration, a yield is increased, and a cost reduction effect is obtained.

By the above method for forming the pattern and the method for manufacturing the magnetoresistance effect layer using the method for forming the pattern, a magnetoresistance effect type head that is provided with a magnetoresistance effect layer, a magnetic recording medium for recording, a surface vertical current injection type spin valve, a device using current induction spin switching, a device using BMR, information reproducing equipment, a device using a magnetoresistance effect, a magnetic recording medium and a nonvolatile memory device may be effectively manufactured.

In addition, since the third embodiment of the present invention can form a fine magnetic pattern without a complicated process such as etching, filling, planarizing, washing and the like, a manufacturing process is simplified and cost is largely reduced.

Accordingly, the third embodiment of the present invention can obtain an increase effect of precise formation of the magnetic pattern that has high density and various shapes by irradiating the accelerated hydrogen ion in a plasma state or hydrogen ion beam on the mask pattern that has high density and various shapes and is formed by the nano imprinting process using the stamp with the nanostructure is formed.

In addition, the third embodiment of the present invention can form a magnetic storing medium that has small defects and a flat upper part by using the method for forming the magnetic pattern and be applied to a patterned media.

In addition, the third embodiment according to the present invention, by using a stamp with nano patterns, since the same mask pattern as a predetermined pattern on the stamp is formed and the same form and size as the mask pattern are reproduced on the pattern forming layer, a nanosize magnetic pattern that is capable of being used as a patterned media that is a magnetic storing medium may be formed.

In addition, according to the present invention, by using a stamp with nano patterns, since the same mask pattern as a predetermined pattern on the stamp is formed and the same form and size as the mask pattern are ensured on the pattern forming layer, a nanosize magnetic pattern that is capable of being used as a patterned media that is a magnetic storing medium may be formed. The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A method for forming a magnetic pattern, the method comprising the steps of:
(a) coating a pattern forming layer for fabricating a magnetic pattern on a substrate;
(b) forming a mask layer that has a designed opening pattern by a nano imprinting process using a stamp that has a nanostructure pattern on the pattern forming layer; and
(c) converting an area of the pattern forming layer that corresponds to the predetermined opening pattern into a magnetic area by irradiating a predetermined hydrogen ion beam onto the mask layer with acceleration.

2. A method for forming a magnetic pattern, the method comprising the steps of:
(a) coating a pattern forming layer for fabricating a magnetic pattern on a substrate;
(b) forming a mask layer that has a predetermined opening pattern with a nano imprinting process using a stamp that has a nanostructure pattern on the pattern forming layer; and
(c) converting an area of the pattern forming layer that corresponds to the predetermined opening pattern into a magnetic area by irradiating a hydrogen ion in a plasma state onto the mask layer.

3. The method for forming a magnetic pattern as set forth in claim 1, wherein in the stamp, a side on which the nanostructure pattern is formed is flat.

4. The method for forming a magnetic pattern as set forth in claim 1, wherein in step (b), the nano imprinting process is a hot embossing method.

5. The method for forming a magnetic pattern as set forth in claim 1, wherein in step (b), the nano imprinting process is a UV embossing method.

6. The method for forming a magnetic pattern as set forth in claim 1, wherein in step (c), energy of hydrogen ion is irradiated at the intensity of 2 keV or less.

7. The method for forming a magnetic pattern as set forth in claim 1, wherein in step (a), the pattern forming layer includes at least one of B, Co, Fe, Ni, Ta, Ru, Ti, Pt, Au, Mn, Pd, Cu, Cr, C, Zn, Zr, Y, Nb, Mo, Rh, Ag, Hf, W, Re, Al, Os, Ir, and Nb.

8. The method for forming a magnetic pattern as set forth in claim 1, wherein in step (a), the pattern forming layer is formed of any one of oxide, nitride, and sulfide.

9. The method for forming a magnetic pattern as set forth in claim 1, wherein in step (a), the pattern forming layer is formed of CoₓFe_{y} oxide, and x and y satisfy the correlation that x+y=1, 0≦x≦1, and 0≦y≦1.

10. A method for manufacturing a patterned media through formation of a magnetic pattern, the method comprising the steps of:
(a) coating a pattern forming layer for fabricating a magnetic pattern on a substrate;
(b) forming a mask layer that has a predetermined nanodot pattern with a nano imprinting process using a stamp that has a nanostructure pattern on the pattern forming layer; and
(c) converting an area of the pattern forming layer that corresponds to the predetermined nanodot pattern into a magnetic area by irradiating a predetermined hydrogen ion or hydrogen ion beam onto the mask layer.

11. The method for manufacturing a patterned media as set forth in claim 10, wherein in the stamp, a side on which the nanostructure pattern is formed is flat.

12. The method for manufacturing a patterned media as set forth in claim 10, wherein in step (b), the nano imprinting process is a hot embossing method.

13. The method for manufacturing a patterned media as set forth in claim 10, wherein in step (b), the nano imprinting process is a UV embossing method.

14. The method for manufacturing a patterned media as set forth in claim 10, wherein in step (c), energy of hydrogen ion is irradiated at the intensity of 2 keV or less.

15. The method for manufacturing a patterned media as set forth in claim 10, wherein in step (a), the pattern forming layer includes at least one of B, Co, Fe, Ni, Ta, Ru, Ti, Pt, Au, Mn, Pd, Cu, Cr, C, Zn, Zr, Y, Nb, Mo, Rh, Ag, Hf, W, Re, Al, Os, Ir, and Nb.

16. The method for manufacturing a patterned media as set forth in claim 10, wherein in step (a), the pattern forming layer is formed of any one of oxide, nitride, and sulfide.

17. The method for manufacturing a patterned media as set forth in claim 10, wherein in step (a), the pattern forming layer is formed of CoₓFe_{y} oxide, and x and y satisfy the correlation that x+y=1, 0≦x≦1, and 0≦y≦1.

18. The method for manufacturing a patterned media as set forth in claim 10, wherein in step (a), the pattern forming layer is formed of a unit coated layer in which one or more magnetic layers and a non-magnetic layer disposed between the magnetic layers.

19. The method for manufacturing a patterned media as set forth in claim 10, wherein pattern forming layer of the step (a) is formed by laminating one or more unit coated layers.

20. The method for manufacturing a patterned media as set forth in claim 18, further comprising:
forming an antiferromagnetic layer on at least one of upper and lower sides of the one or more unit coated layers.

21. (canceled)
